(19) United States
(12) Patent Application Publication
(10) Pub. No.: US 2018/0366949 A1
(43) Pub. Date: Dec. 20, 2018

(54) Systems Using Data Streams to Feed Optimization Engines in Power System Operations

(71) Applicant: General Electric Technology GmbH, Baden (CH)

(72) Inventors: Torrance James McKeag, Redmond, WA (US); Shilpa Murugendra, Redmond, WA (US)

(21) Appl. No.: 15/676,182

(22) Filed: Aug. 14, 2017

(30) Foreign Application Priority Data
Jun. 16, 2017 (IN) 201741021124

(51) Int. Cl. H02J 3/00; G06Q 10/04; G06Q 50/06; G06Q 30/02

(52) U.S. Cl. CPC H02J 3/008; G06Q 10/04; H02J 2003/003; G06Q 30/0205; G06Q 50/06

(57) ABSTRACT

Systems and methods for using data streams to feed optimization engines in power system operations are provided. A system for unit commitment optimization in power system operations may include a streaming node and a processing node. The streaming node may be configured to receive energy market data from a plurality of input sources. The processing node may be configured to partition the energy market data into one or more selected data streams monitored by at least one unit commitment resolver host. The at least one unit commitment resolver host may be configured to input the partitioned energy market data into a unit commitment model in anticipation of at least one unit commitment solution request by a power grid operating entity. The processing node may be further configured to provide the partitioned energy market data to a client device associated with the power grid operating entity upon receipt of a unit commitment solution request.

### CROSS-REFERENCE TO RELATED APPLICATIONS

This application claims priority to and benefit of Indian Patent Application No. 201741021124, entitled “Using Data Streams To Feed Optimization Engines In Power System Operations,” filed Jun. 16, 2017, which are incorporated herein by reference in their entirety.

### TECHNICAL FIELD

This disclosure relates generally to power system operations, and more particularly, to systems and methods for using data streams to feed optimization engines in power system operations.

### BACKGROUND

As part of the normal operation of energy markets, transmission system operators entrusted with transporting energy on a national or regional level may regularly solve unit commitment problems. A unit commitment problem may involve multiple mathematical optimizations directed to coordinating the energy production by energy-generating units, such as electrical generators. The unit commitment problem may further involve determining schedules for operations of the generating units and providing sufficient energy to meet energy demands at a minimum cost and/or making the energy production more efficient. The unit commitment problem is related to an economic dispatch. The economic dispatch involves determination of an optimal output of the electrical generators to produce energy at the lowest possible cost under specific operational limits and transmission constraints. The economic dispatch and the unit commitment are included in regular power system operations. Traditionally, to meet rules of energy markets, deterministic optimization methods are used. However, the traditional deterministic optimization methods may need complete input data sets.

Thus, in order for traditional optimization algorithms to work, an optimization engine may need a complete set of all data inputs before a solution can be provided. This makes solving the unit commitment problem challenging because there may be a large number of data inputs that come from disparate data sources and that are created at different times by various systems. Accordingly, before running the optimization, all data inputs may need to be collected, validated, and applied to an optimization engine.

Furthermore, conventional data collection systems may rely on bulk data aggregation, i.e. batch serialized job, to pull data inputs on demand of the optimization engine, validate the data, and apply an optimization model to the data, which may result in a significant performance bottleneck upon receiving the demand from the optimization engine. Moreover, some conventional data collection systems may attempt to co-locate a processing system with the data. As a result, the processing may be pushed to the data rather than the data pushed to the processing.

### BRIEF DESCRIPTION OF THE DISCLOSURE

The disclosure relates to systems and methods for using data streams to feed optimization engines in power system operations. In certain embodiments, systems and methods for unit commitment optimization in power system operations can be provided. According to one embodiment of the disclosure, a system for unit commitment optimization in power system operations is provided. The system may include a streaming node and a processing node. The streaming node may be configured to receive energy market data from a plurality of input sources. The processing node may be configured to partition, based at least in part on predetermined business criteria, the energy market data into one or more selected data streams monitored by at least one unit commitment resolver host associated with an optimization engine. The at least one unit commitment resolver host may be configured to input the partitioned energy market data into at least one unit commitment model in anticipation of at least one unit commitment solution request by a power grid operating entity. The processing node may be further configured to transmit some or all of the partitioned energy market data to a client device associated with the power grid operating entity upon receipt of a unit commitment solution request.

In another embodiment of the disclosure, a method for unit commitment optimization in power system operations is provided. The method may include receiving energy market data from a plurality of input sources. The method may further include partitioning the energy market data into a plurality of data streams based on predetermined business criteria. The method may continue with feeding the energy market data via the plurality of data streams to at least one unit commitment resolver host associated with an optimization engine. The at least one unit commitment resolver host may be configured to preprocess the energy market data based on at least one unit commitment model in anticipation of at least one unit commitment solution request by a power grid operating entity.

In yet another embodiment of the disclosure, a system for unit commitment optimization in power system operations can be provided. The system can include a streaming node configured to receive energy market data from a plurality of input sources. The system can also include a processing node configured to partition, based at least in part on predetermined business criteria, the energy market data to one or more selected data streams monitored by at least one unit commitment resolver host associated with an optimization engine, wherein the at least one unit commitment resolver host is configured to input the partitioned energy market data to at least one unit commitment model in anticipation of at least one unit commitment solution request by a power grid operating entity. The processing node can also be configured to publish the one or more selected data streams for subscription by the at least one unit commitment resolver host. Further, the processing node can also be configured to serve the partitioned energy market data via the one or more selected data streams to at least one subscribed unit commitment resolver host. Moreover, the processing node can also be configured to collect parts of the energy market data. Furthermore, the processing node can also be configured to validate the parts of the energy market data to obtain validated parts of the energy market data. The processing node can also be configured to populate at least one cache of the at least one unit commitment model with the validated parts of the energy market data. The processing node can also be configured to compile the validated parts of the energy market data into an optimization model. Finally, the processing node can also be configured to, upon receipt of a unit commitment solution request, transmit some or all of the validated parts of the energy market data to a client device associated with the power grid operating entity.

Other embodiments and aspects will become apparent from the following description taken in conjunction with the following drawings.

### BRIEF DESCRIPTION OF THE DRAWINGS

FIG. 1 is a block diagram illustrating an example system environment for implementing systems and methods for unit commitment optimization in power system operations, in accordance with one or more example embodiments of the disclosure.

FIG. 2 is a block diagram illustrating an example unit commitment optimization in power system operations, in accordance with one or more example embodiments of the disclosure.

FIG. 3 is an example block diagram illustrating an example system for unit commitment optimization in power system operations, in accordance with one or more example embodiments of the disclosure.

FIG. 4 is a process flow diagram illustrating an example method for unit commitment optimization in power system operations, in accordance with one or more example embodiments of the disclosure.

FIG. 5 is a block diagram illustrating an example controller for integrating computing analytics within a processing environment, in accordance with an embodiment of the disclosure.

### DETAILED DESCRIPTION

The following detailed description includes references to the accompanying drawings, which form part of the detailed description. The drawings depict illustrations, in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

Certain embodiments of the disclosure described herein relate to systems and methods for systems and methods for using data streams to feed optimization engines in power system operations, such as unit commitment optimization in power system operations. According to an example method, energy market data may be aggregated from various input sources. The input sources may include transmission system operators, such as state estimators, supervisory control and data acquisition (SCADA) systems, market participant portals, neighboring operators, government entities, such as the North American Electric Reliability Corporation, and so forth. The energy market data may be either pulled by or pushed into a streaming system. Once received by the streaming system, the energy market data may be partitioned into different data streams based on predetermined criteria to scale out the overall volume of the energy market data that can pass through the streaming system.

Once the energy market data are captured in the data streams, the streaming system may feed the energy market data using the data streams to a unit commitment resolver host. The unit commitment resolver host may be a SCUC (security constrained unit commitment) application host of a system responsible for solving unit commitment problems and running SCUC. The unit commitment resolver host may preprocess the energy market data based on a unit commitment model. The preprocessing of the energy market data may be performed in anticipation of receiving a unit commitment solution request from a power grid operating entity. Specifically, the unit commitment resolver host may collect the energy market data from the data streams, validate the energy market data, and populate a cache of the unit commitment model with the validated energy market data. Upon receiving the unit commitment solution request from the power grid operating entity, the energy market data may be analyzed and optimized by the unit commitment resolver host and a unit commitment solution may be run for the power grid operating entity based on the optimized energy market data. Thus, considerable time and resources for data and model preparations may be spent prior to receiving a request of the power grid operating entity.

The technical effects of certain embodiments of the disclosure may include collecting and preprocessing the energy market data in anticipation of requests for unit commitment solutions. Additionally, technical effects of certain embodiments of the disclosure may include eliminating significant data input read time and model population time in solving unit commitment and economic dispatch problems. Furthermore, timing of production of the data inputs may be decoupled from the need to feed the data inputs into an optimization model.

The following provides a detailed description of various example embodiments of the disclosure related to systems and methods for unit commitment optimization in power system operations.

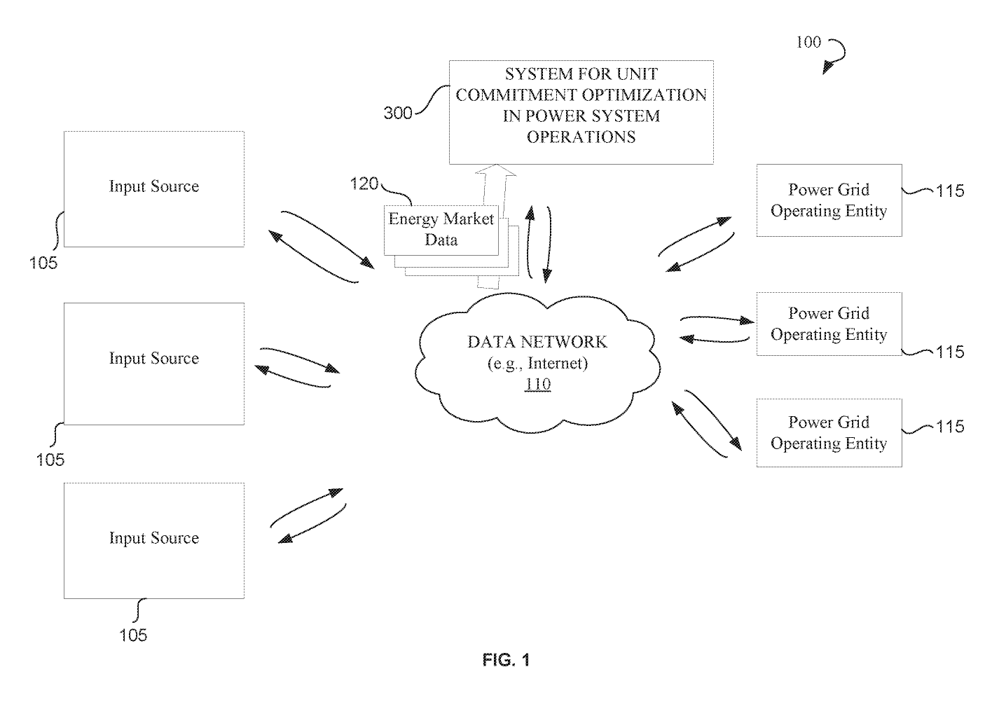

Referring now to FIG. 1, a block diagram illustrates an example system environment 100 that can be suitable for implementing systems and methods for unit commitment optimization in power system operations, in accordance with one or more example embodiments. The example system environment 100 illustrates a plurality of input sources 105, a plurality of power grid operating entities 115, and a system 300 for unit commitment optimization in power system operations connected to a data network 110.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network 110 may include a network of data processing nodes that may be interconnected for the purpose of data communication.

The input sources 105 may be configured to aggregate energy market data 120 and provide the energy market data 120 to the system 300 via the data network 110. The input sources 105 may include state estimators, SCADA systems, market participant portals for participants of the energy market, neighboring grid operators, government entities, and so forth. In an example embodiment, a state estimator may be configured to collect parameters sensed or measured by different devices, e.g. by sensors. The parameters may include sensor inputs, operating frequencies, dynamic pressures, and so forth. The state estimator may provide the collected parameters to a processing model associated with a plant, an engine, and so forth. The processing model may be used to generate one or more state parameters that can include estimates of performance parameters for the plant. The SCADA systems may include software application programs for process control, gathering of data in real time from remote locations in order to control equipment and operating conditions.

The power grid operating entities 115 may include utilities and electric power transmission system operators connected to the system 300. In an example embodiment, the electric power transmission system operators may include an independent system operator controlling the operation of the electric power system within a single state or several states of a country, and a regional transmission operator controlling the operation of a multi-state electric grid. The power grid operating entities 115 may use the system 300 to solve the unit commitment problems based on the energy market data 120 supplied to the system 300 from the input sources 105.

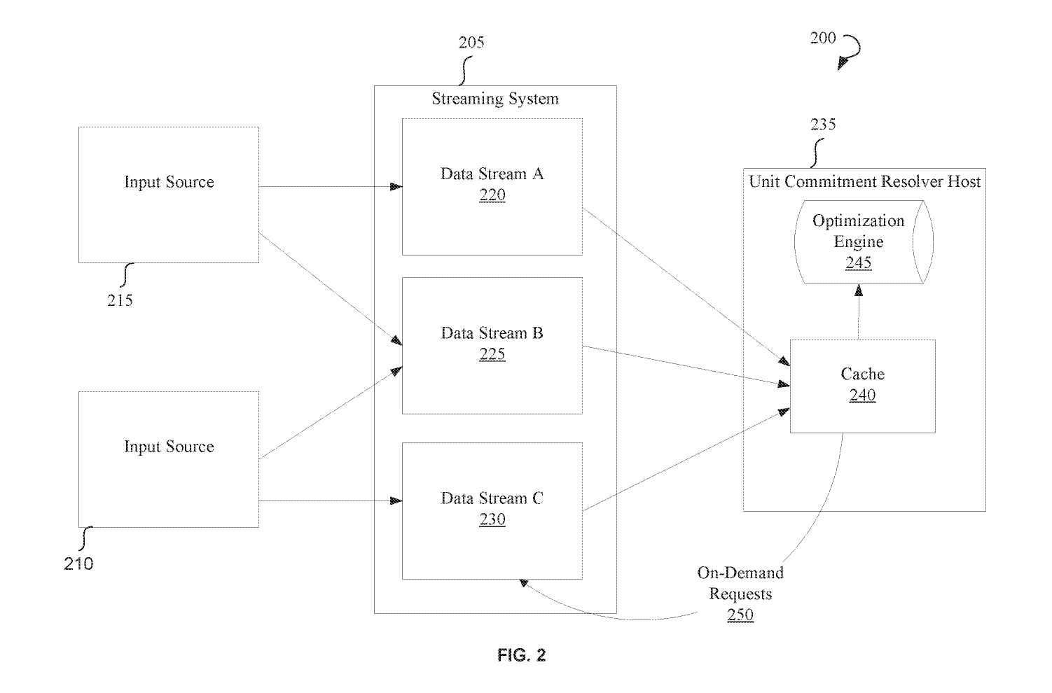

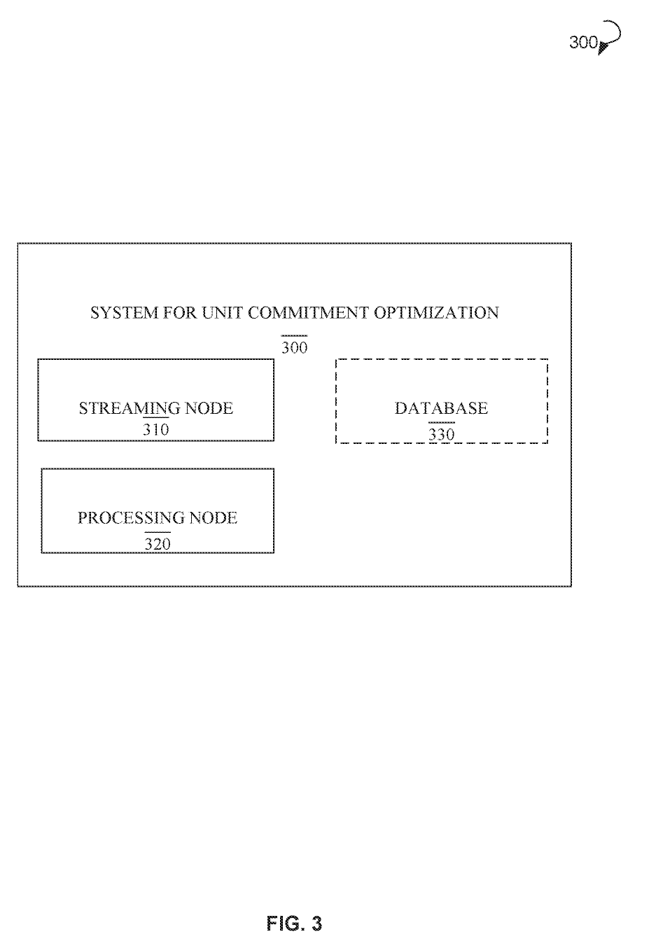

FIG. 2 is block diagram 200 illustrating unit commitment optimization in power system operations, in accordance with certain embodiments of the disclosure. The commitment optimization may be performed using a streaming system 205. In an example embodiment, the streaming system 205 may include a system 300 for unit commitment optimization in power system operations as shown in FIGS. 1 and 3.

The streaming system 205 may aggregate data inputs for the unit commitment problem from a plurality of sources shown as an input source 210 and an input source 215. The data inputs may include energy market data. The data inputs may be either pushed to or pulled by the streaming system 205 depending on predetermined criteria for a business procedure of power grid operating entities. Once pulled or pushed, the data inputs may be partitioned by the streaming system 205 into different data streams shown as a data stream A 220, data stream B 225, and data stream C 230. The partitioning of the data inputs may allow for different retention and storage operations and for scaling out the volume of the energy market data that can pass through the streaming system 205. The strategy for partitioning the data inputs into the data stream A 220, data stream B 225, and data stream C 230 may be configurable to allow for scalability and performance tuning of the system 200.

Once the energy market data have been captured into the data stream A 220, data stream B 225, and data stream C 230, the streaming system 205 may notify a unit commitment resolver host 235 connected to the streaming system 205 that the energy market data are available and can be pushed to a cashing layer shown as a cache 240 associated with the unit commitment resolver host 235. The unit commitment resolver host 235 may include, for example, a SCUC application host of a unit commitment resolver. The unit commitment resolver may include a power grid operating entity. Though one unit commitment resolver host 235 is shown on FIG. 2, it should be understood that a plurality of unit commitment resolver hosts of a plurality of unit commitment resolvers may receive the energy market data from the streaming system 205. In some example embodiment, a plurality of software instances associated with the unit commitment resolvers may be run on the unit commitment resolver host 235. In another example embodiment, the unit commitment resolver host 235 may include a distributed set of servers running a unit commitment engine used for solving unit commitment and economic dispatch problems.

The streaming system 205 may populate the energy market data from the data stream A 220, data stream B 225, and data stream C 230, into the cache 240 on the unit commitment resolver host 235. More specifically, the energy market data may be populated into an appropriate portion of a unit commitment model of the unit commitment resolver host 235. The unit commitment resolver host 235 may provide the energy market data to an optimization model of an optimization engine 245 in anticipation of receiving a request from a power grid operating entity to run a unit commitment solution. Therefore, when the unit commitment solution is run upon receipt of the request from the power grid operating entity, the operations of collecting and preprocessing the energy market data have been already completed. Because the energy market data are already collected and prepopulated into the unit commitment model, the unit commitment and economic dispatch may be performed faster than with conventional techniques in which the energy market data are fetched from the input sources on demand, i.e. only upon receipt of a request from a power grid operating entity.

In some example embodiments, the unit commitment resolver host 235 may be unavailable while the energy market data are streamed to the unit commitment resolver host 235 by the streaming system 205. Therefore, certain portions of the energy market data may not be in the cache 240. In this case, the unit commitment resolver host 235 may send on-demand requests 250 to the streaming system 205 to obtain the lacking portions of the energy market data. Size management operations may be used to manage footprints associated with the cache 240, i.e. resource requirements of the cache 240. The cache 240 may store the energy market data into client libraries. The client libraries may be associated with the power grid operating entities.

In certain embodiments, the caching may be implemented using memory-mapped files representing segments of virtual memory that have been assigned a direct byte-for-byte correlation with some portion of a file or file-like resource. The resource may include a file that is physically present on a disk, include a device, a shared memory object, or other resource. The correlation between the file and the memory space may permit the unit commitment resolver host 235 to treat the mapped portion of the file as if the mapped portion were a memory directly accessible by a central processing unit associated with the unit commitment resolver host 235.

In further example embodiments, the power grid operating entities may wish to run the unit commitment solution against older energy market data. In this case, the unit commitment resolver host 235 can request older portions of the energy market data by sending the on-demand requests 250 to the streaming system 205. The streaming system 205 may, in turn, request the older portions of the energy market data from the input sources 210 and 215.

FIG. 3 is block diagram illustrating various example modules of the system 300 for unit commitment optimization in power system operations, in accordance with certain embodiments of the disclosure. The system 300 may include a streaming node 310, a processing node 320, and, optionally, a database 330. Each of the streaming node 310 and the processing node 320 can be part of a central processing unit and can include a programmable processor, such as a microcontroller, a central processing unit, and so forth. In other embodiments, each of the streaming node 310 and the processing node 320 can include an application-specific integrated circuit or a programmable logic array, such as a field programmable gate array, designed to implement the functions performed by the system 300. The database 330 can be operable to receive and store at least energy market data, predetermined business criteria for partitioning the energy market data, and so forth.

The streaming node 310 may be configured to receive energy market data from a plurality of input sources. The energy market data may include one or more of the following: a market bid, a market forecast, a reserve requirement, power system sensor data, an offer from power plant owners, a demand forecast, and so forth. The input sources may include one or more of the following: a field power system sensor, a state estimator, a SCADA system, a government entity, a power plant operator, a market participant, such as owners of power plants and wind farms, and so forth. In an example embodiment, each of the plurality of input sources may be assigned to a specific data stream of the one or more selected data streams based on one or more of the following tasks: predicting a day-ahead market, taking bids from energy market participants to create financial commitments, forecasting a demand, estimating a state, predicting a reserve requirement, and so forth.

The processing node 320 may partition the energy market data received by the streaming node 310 into one or more selected data streams. The one or more selected data streams may be partitioned based at least in part on predetermined business criteria. The predetermined business criteria may include configuring the selected data streams for different kinds of business processes performed by a unit commitment resolver. In an example embodiment, the unit commitment resolver may perform unit commitment for a day ahead market. The day ahead market is an electricity market enabling purchases (through bids to buy), sales (through offers to sell), and short-term trades performed by market participants. The bids and offers from the market participants may be used to create financial commitments. The selected data streams may be configured for the unit commitment for the day ahead market and one of the selected data streams can include bids so that a power grid operating entity may run the unit commitment solution based on the bids.

Another configuration mode of the selected data streams can be selected later for the power grid operating entity to run a reliability unit commitment solution. Therefore, the same mathematical problem of collecting the energy market data may be solved for a different purpose. Instead of taking the financial commitment from an optimization model, the power grid operating entity may take the financial commitment from the day ahead market. In this case, instead of configuring the selected data stream to pull in the bids, the selected data stream may be configured to pull in a demand forecast. Thus, the power grid operating entity can receive financial commitments to ensure the grid reliability is met.

Another example embodiment of configuring the selected data streams based on predetermined business criteria may include solving the unit commitment problem in real time. In this embodiment, the selected data stream may include data inputs of a state estimator or an energy management system. The state estimator may be bringing in the state of the current power network needed by the power grid operating entity needs if the power grid operating entity solves the unit commitment problem in real time. The data associated with the selected data stream may be event-based and of varied frequency, i.e. the state estimator may run every minute, couple of minutes, with some types of data possibly produced by input sources once a day, and so forth. As the state estimator publishes a new data estimator solution, the new data estimator solution is pushed into the selected data stream and delivered to the at least one unit commitment resolver host.

The one or more selected data streams may be monitored by at least one unit commitment resolver host associated with an optimization engine. The at least one unit commitment resolver host may be configured to input the partitioned energy market data into at least one unit commitment model. In an example embodiment, the at least one unit commitment model may include a mathematical model configured to perform calculations using MIP algorithms. The partitioned energy market data may be provided to the at least one unit commitment model in anticipation of at least one unit commitment solution request by the power grid operating entity. Upon receipt of a unit commitment solution request, the processing node 320 may transmit some or all of the partitioned energy market data to a client device associated with the power grid operating entity.

In an example embodiment, the at least one unit commitment resolver host may be further configured to preprocess the partitioned energy market data. Specifically, the at least one unit commitment resolver host may collect parts of the energy market data and validate the parts of the energy market data to obtain validated parts of the energy market data. The at least one unit commitment resolver host may further populate at least one cache of the at least one unit commitment model with the validated parts of the energy market data. The at least one unit commitment resolver host may compile the validated parts of the energy market data into the optimization model.

In an example embodiment, the processing node 320 may be further configured to publish the one or more selected data streams for subscription by the at least one unit commitment resolver host. For this purpose, publish-subscribe patters may be used according to which senders of messages, i.e. publishers, instead of programming the messages to be sent directly to specific receivers, i.e. subscribers, assign classes to published messages without knowledge of specific subscribers. The subscriber, i.e. a unit commitment resolver solving unit commitment and economic dispatch problems, may configure the at least one unit commitment resolver host to subscribe for one or more classes of messages in which the subscriber is interested. Therefore, the processing node 320 may be configured to serve some or all of the partitioned energy market data via the one or more selected data streams to the at least one unit commitment resolver host subscribed for the partitioned energy market data associated with specific data streams. The specific data streams may be selected by the unit commitment resolver during the subscription process.

Thus, the at least one unit commitment resolver host may receive specific energy market data for which the at least one unit commitment resolver host is subscribed, such as, state estimator solutions, day-ahead bids, and so forth.

The at least one unit commitment resolver host may be further configured to request historical energy market data or missing energy market data from at least one data stream of the plurality of data streams. Therefore, the missing energy data of the energy market or the energy data timed out in the cache may be fetched, if needed, by the at least one unit commitment resolver host to support the system 300 or to perform further analysis of historical data associated with the energy market data.

In an example embodiment, the processing node 320 may be further configured to run at least one unit commitment solution in response to the at least one unit commitment solution request received from the power grid operating entity. The at least one unit commitment solution may include an economic dispatch and a unit commitment. The at least one unit commitment solution may be run using MIP algorithms. Therefore, the system 300 may provide significant performance, reliability, and repeatability to power grid operating entities that request unit commitment solutions.

The optimization engine may be configured to create a further data stream for a specific business solution. Specifically, if some of the energy market data are not in the data streams for which the subscriber is subscribed, the optimization engine may provide such energy market data via the further data stream. Such further data stream may be provided to the subscriber based on predetermined criteria.

In an example embodiment relating to the day ahead market, a size of input data related to the day ahead market may be relatively large. In conventional solutions with no preprocessing of the input data, there is a cutoff time after which bids and offers are no longer accepted. Thereafter, validations and checks of the input data are performed. The final preprocessed input data captured for the unit commitment are loaded into the optimization engine to enable performing of the unit commitment solution.

The system 300 may collect the energy market data as the energy market data are produced throughout the day. As soon as a market participant creates a new valid bid, the bid is provided to the selected data streams, validated, and prepopulated into the optimization model before the day ahead market closes. Thus, the power grid operating entity can launch the unit commitment solution immediately upon the day ahead market closes without having to wait for the validation to occur because all the bids are already validated and prepopulated into the optimization model.

Moreover, while the day ahead market is open, conflicting versions of bids and offers may be validated and replaced with non-conflicting versions. Thus, by the time the day ahead market closes, the unit commitment solution may be ready to be run. In other words, the energy market data may be constantly updated within the optimization model.

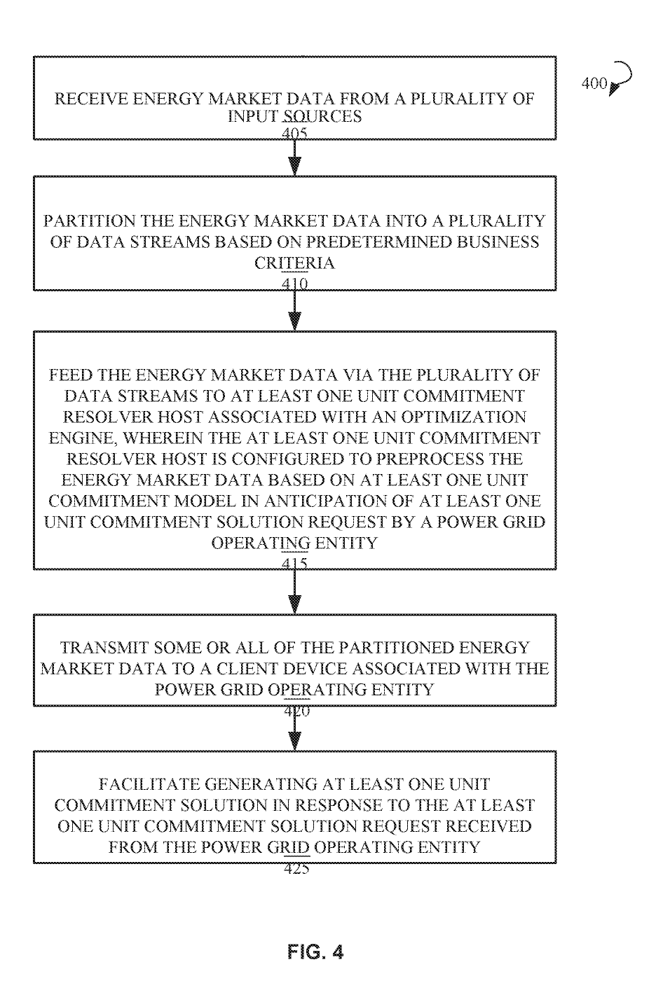

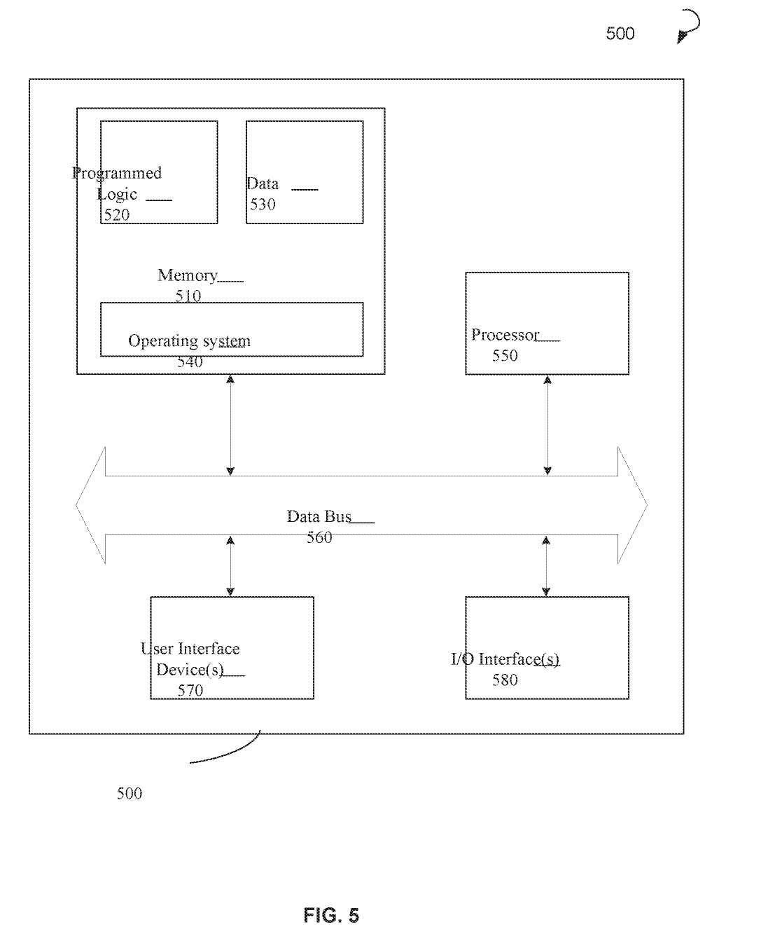

FIG. 4 depicts a process flow diagram illustrating a method 400 for unit commitment optimization in power system operations, in accordance with an embodiment of the disclosure. The method 400 may be performed by processing logic that may comprise hardware (e.g., dedicated logic, programmable logic, and microcode), software (such as software run on a general-purpose computer system or a dedicated machine), or a combination of both. In one example embodiment, the processing logic resides at a controller 500 shown on FIG. 5, which may reside in a user device or in a server. The controller 500 may comprise processing logic. It will be appreciated by one of ordinary skill in the art that instructions said to be executed by the controller 500 may, in fact, be retrieved and executed by one or more processors. The controller 500 may also include memory cards, servers, and/or computer disks. Although the controller 500 may be configured to perform one or more steps described herein, other control units may be utilized while still falling within the scope of various embodiments.

As shown in FIG. 4, the method 400 may commence at operation 405 with receiving, by a streaming system, energy market data from a plurality of input sources. In an example embodiment, the plurality of input sources may include one or more of the following: a field power system sensor, a state estimator, a SCADA system, a market participant, a government entity, a power plant operator, and so forth. The energy market data may include one or more of the following: a market bid, a market forecast, a reserve requirement, power system sensor data, an offer from power plant owners, a demand forecast, and so forth.

The method 400 may continue with partitioning, by the streaming system, the energy market data into a plurality of data streams at operation 410. The partitioning may be performed based on predetermined business criteria. In an example embodiment, each of the plurality of input sources may be assigned to a specific data stream of the plurality of data streams based on one or more of the following tasks: predicting a day-ahead market, taking bids from market participants to create financial commitments, a forecasting demand, estimating a state, predicting a reserve requirement, and so forth.

At operation 415, the energy market data may be fed, by the streaming system, via the plurality of data streams to at least one unit commitment resolver host associated with an optimization engine. The at least one unit commitment resolver host may be configured to preprocess the energy market data based on at least one unit commitment model in anticipation of at least one unit commitment solution request by a power grid operating entity.

In an example embodiment, the preprocessing of the energy market data by the at least one unit commitment resolver host may include collecting and validating parts of the energy market data. Thus, validated parts of the energy market data may be obtained. The validated parts of the energy may be populated into at least one cache of the at least one unit commitment model. The preprocessing may further include compiling the validated parts of the energy market data into an optimization model.

In an example embodiment, the energy market data may be fed to the at least one unit commitment resolver host by publishing the plurality of data streams for subscription by the at least one unit commitment resolver host. The energy market data may be served, via the plurality of data streams, to the at least one subscribed unit commitment resolver host, i.e. the at least one unit commitment resolver host subscribed for the energy market data associated with one or more specific data streams.

In a further example embodiment, the at least one unit commitment resolver host may be configured to request historical energy market data associated with at least one data stream of the plurality of data streams. Additionally, the at least one unit commitment resolver host may be configured to request missing energy market data associated with at least one data stream of the plurality of data streams. Upon the request, the historical energy market data and the missing energy market data may be provided to the at least one unit commitment resolver host from the at least one data stream.

The method 400 may further include transmitting some or all of the partitioned energy market data to a client device associated with the power grid operating entity at operation 420. The partitioned energy market data may be transmitted to the power grid operating entity upon receipt of a unit commitment solution request from the power grid operating entity.

At operation 425, generating of at least one unit commitment solution may be facilitated in response to the at least one unit commitment solution request received from the power grid operating entity. In other words, the at least one unit commitment solution may be run in response to receipt of the at least one unit commitment solution request from the power grid operating entity.

FIG. 5 depicts a block diagram illustrating an example controller 500 for integrating computing analytics within a processing environment, in accordance with an embodiment of the disclosure. More specifically, components of the controller 500 can be used for performing unit commitment optimization in power system operations. The controller 500 may include a memory 510 that stores programmed logic 520 (e.g., software) and may store data 530, such as geometrical data and the operation data of a power plant, a dynamic model, performance metrics, and the like. The memory 510 also may include an operating system 540.

A processor 550 may utilize the operating system 540 to execute the programmed logic 520, and in doing so, may also utilize the data 530. A data bus 560 may provide communication between the memory 510 and the processor 550. Users may interface with the controller 500 via at least one user interface device 570, such as a keyboard, mouse, control panel, or any other devices capable of communicating data to and from the controller 500. The controller 500 may be in communication with the power plant online while operating, as well as in communication with the power plant offline while not operating, via an input/output (I/O) interface 580.

The controller 500 and the programmed logic 520 implemented thereby may include software, hardware, firmware, or any combination thereof. It should also be appreciated that multiple controllers 500 may be used, whereby different features described herein may be executed on one or more different controllers 500.

References are made to block diagrams of systems, methods, apparatuses, and computer program products according to example embodiments. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a non-transitory, computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide operations for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A system for unit commitment optimization in power system operations, the system comprising:
a streaming node configured to:
receive energy market data from a plurality of input sources; and
a processing node configured to:
partition, based at least in part on predetermined business criteria, the energy market data to one or more selected data streams monitored by at least one unit commitment resolver host associated with an optimization engine, wherein the at least one unit commitment resolver host is configured to input the partitioned energy market data to at least one unit commitment model in anticipation of at least one unit commitment solution request by a power grid operating entity; and
upon receipt of a unit commitment solution request, transmit some or all of the partitioned energy market data to a client device associated with the power grid operating entity.

2. The system of claim 1, wherein the plurality of input sources include one or more of the following: a field power system sensor, a state estimator, a supervisory control and data acquisition system, a market participant, a government entity, and a power plant operator.

3. The system of claim 2, wherein each of the plurality of input sources is assigned to a specific data stream of the one or more selected data streams based on one or more of the following tasks: predicting a day-ahead market, taking bids from market participants to create financial commitments, forecasting a demand, estimating a state, and predicting a reserve requirement.

4. The system of claim 1, wherein the processing node is further configured to:
publish the one or more selected data streams for subscription by the at least one unit commitment resolver host; and
serve some or all of the partitioned energy market data via the one or more selected data streams to at least one subscribed unit commitment resolver host.

5. The system of claim 1, wherein the at least one unit commitment resolver host is further configured to perform at least one of the following:
collect parts of the energy market data;
validate the parts of the energy market data to obtain validated parts of the energy market data;
populate at least one cache of the at least one unit commitment model with the validated parts of the energy market data; and
compile the validated parts of the energy market data into an optimization model.

6. The system of claim 5, wherein the processing node is further configured to run at least one unit commitment solution in response to the at least one unit commitment solution request received from the power grid operating entity.

7. The system of claim 6, wherein the at least one unit commitment solution includes an economic dispatch and a unit commitment.

8. The system of claim 1, wherein the at least one unit commitment resolver host is further configured to request historical energy market data associated with at least one data stream of the plurality of data streams or missing energy market data.

9. The system of claim 1, wherein the energy market data includes one or more of the following: a market bid, a market forecast, a reserve requirement, power system sensor data, an offer from power plant owners, and a demand forecast.

10. The system of claim 1, wherein the optimization engine is configured to create a further data stream for a specific business solution.

11. A method for unit commitment optimization in power system operations, the method comprising:
receiving, by a streaming system, energy market data from a plurality of input sources;
partitioning, by the streaming system, the energy market data into a plurality of data streams based on predetermined business criteria; and
feeding, by the streaming system, the energy market data via the plurality of data streams to at least one unit commitment resolver host associated with an optimization engine, wherein the at least one unit commitment resolver host is configured to preprocess the energy market data based on at least one unit commitment model in anticipation of at least one unit commitment solution request by a power grid operating entity.

12. The method of claim 11, wherein the plurality of input sources include one or more of the following: a field power system sensor, a state estimator, a supervisory control and data acquisition system, a market participant, a government entity, and a power plant operator.

13. The method of claim 12, wherein each of the plurality of input sources is assigned to a specific data stream of the plurality of data streams based on one or more of the following tasks: predicting a day-ahead market, taking bids from market participants to create financial commitments, forecasting demand, estimating a state, and predicting a reserve requirement.

14. The method of claim 11, wherein the feeding the energy market data via the plurality of data streams to the at least one unit commitment resolver host includes:
publishing the plurality of data streams for subscription by the at least one unit commitment resolver host; and
serving the energy market data via the plurality of data streams to the at least one subscribed unit commitment resolver host.

15. The method of claim 11, wherein the preprocessing of the energy market data by the at least one unit commitment resolver host includes at least one of the following:
collecting parts of the energy market data;
validating the parts of the energy market data to obtain validated parts of the energy market data;
populating at least one cache of the at least one unit commitment model with the validated parts of the energy market data; and
compiling the validated parts of the energy market data into an optimization model.

16. The method of claim 11, further comprising running at least one unit commitment solution in response to the at least one unit commitment solution request received from the power grid operating entity.

17. The method of claim 11, wherein the at least one unit commitment resolver host is further configured to request historical energy market data associated with at least one data stream of the plurality of data streams or missing energy market data.

18. The method of claim 11, wherein the energy market data includes one or more of the following: a market bid, a market forecast, a reserve requirement, power system sensor data, an offer from power plant owners, and a demand forecast.

19. The method of claim 11, wherein the optimization engine is configured to create a further data stream for a specific business solution.

20. A system for unit commitment optimization in power system operations, the system comprising:
a streaming node configured to:
receive energy market data from a plurality of input sources; and
a processing node configured to:
partition, based at least in part on predetermined business criteria, the energy market data to one or more selected data streams monitored by at least one unit commitment resolver host associated with an optimization engine, wherein the at least one unit commitment resolver host is configured to input the partitioned energy market data to at least one unit commitment model in anticipation of at least one unit commitment solution request by a power grid operating entity;
publish the one or more selected data streams for subscription by the at least one unit commitment resolver host;
serve the partitioned energy market data via the one or more selected data streams to at least one subscribed unit commitment resolver host;
collect parts of the energy market data;
validate the parts of the energy market data to obtain validated parts of the energy market data;
populate at least one cache of the at least one unit commitment model with the validated parts of the energy market data;
compile the validated parts of the energy market data into an optimization model; and
upon receipt of a unit commitment solution request, transmit some or all of the validated parts of the energy market data to a client device associated with the power grid operating entity.
